(19) United States
(12) Patent Application Publication
(10) Pub. No.: US 2008/0102675 A1
(43) Pub. Date: May 1, 2008

(54) Locking Cradle for a mobile device

(76) Inventors: Ben Michaeli, South Setauket, NY (US); Carl Thelemann, East Islip, NY (US)

Correspondence Address: FAY KAPLUN & MARCIN, LLP, 150 BROADWAY, SUITE 702, NEW YORK, NY, 10038, US

(21) Appl. No.: 11/554,732

(22) Filed: Oct. 31, 2006

(51) Int. Cl. H01R 13/64

(52) U.S. Cl. 439/248

(57) ABSTRACT

A cradle and a cradle lock for a mobile device having a receiving portion to receive at least a portion of a body of the mobile device, the mobile device being inserted into the receiving portion in an insertion direction and a cradle electrical contact electrically coupling with a corresponding mobile device electrical contact, the cradle electrical contact being deformed by physical contact with the mobile device electrical contact, wherein the cradle electrical contact applies a force to the corresponding mobile device electrical contact in a direction substantially perpendicular to the insertion direction.

### FIELD OF THE INVENTION

The present invention relates to cradle devices used to charge the batteries of a mobile computing device, provide standby power to the mobile computing device and/or transfer data between the mobile computing device and other mobile computing devices and/or fixed computing devices.

### BACKGROUND

Mobile electronic devices are typically connected to a cradle to charge their batteries and/or to exchange data with a fixed computing device. An electrical connection has to be maintained to carry out these actions, usually with electrical contacts on the mobile device pressing against corresponding contacts on the cradle. A contact force is applied to either or both sets of contacts to maintain the electrical connection.

As the mobile electronic devices become smaller and lighter, the contact force necessary to maintain the electrical connection may be sufficiently large to dislodge the mobile device from the cradle. Complex and bulky mechanisms to retain the mobile device within the cradle are often used to oppose the contact forces that tend to eject the device.

### SUMMARY OF THE INVENTION

A cradle for a mobile device having a receiving portion to receive at least a portion of a body of the mobile device, the mobile device being inserted into the receiving portion in an insertion direction and a cradle electrical contact electrically coupling with a corresponding mobile device electrical contact, the cradle electrical contact being deformed by physical contact with the mobile device electrical contact, wherein the cradle electrical contact applies a force to the corresponding mobile device electrical contact in a direction substantially perpendicular to the insertion direction.

A geometric lock for a cradle having guides for receiving a mobile device into the cradle in an insertion direction and cradle electrical contacts for interfacing with corresponding mobile device electrical contacts, the cradle electrical contacts electrically coupling with the mobile device electrical contacts by exerting a force substantially perpendicular to the insertion direction.

### DESCRIPTION OF THE DRAWINGS

FIG. 1 shows an exemplary mobile device and a cradle according to an exemplary embodiment of the present invention.

FIG. 2 shows a detail of a contact portion of the exemplary mobile device shown in FIG. 1.

FIG. 3 shows the exemplary cradle shown in FIG. 1.

FIG. 4 shows a detail side view of the exemplary electrical contacts of the cradle according to the present invention.

FIG. 5 is a detail bottom view of the electrical contacts shown in FIG. 4.

FIG. 6 shows exemplary mobile device electrical contacts when starting to be electrically and mechanically connected to the cradle electrical contacts and initiating deformation of the cradle electrical contacts according to an exemplary embodiment of the present invention.

FIG. 7 shows exemplary mobile device electrical contacts resting on the cradle electrical contacts after the cradle contacts are deformed and a final equilibrium position of the electrical contacts shown in FIG. 6 has been established according to an exemplary embodiment of the present invention.

FIG. 8 shows an exemplary internal side of the cradle electrical contacts in its equilibrium position resting on the cradle housing before the mobile device is inserted into the cradle as shown in FIG. 6.

### DETAILED DESCRIPTION

The present invention may be further understood with reference to the following description and to the appended drawings, wherein like elements are referred to with the same reference numerals. The present invention relates to cradle devices used to charge the batteries of a mobile computing device, provide standby power to the mobile computing device and/or transfer data between the mobile computing device and other mobile computing devices and/or fixed computing devices. While the exemplary embodiments of the present invention are described with reference to a specific mobile computing device and cradle configuration shown in the figures, those skilled in the art will understand that the exemplary embodiments are applicable to any computing device/cradle combination.

Charging cradles are used to provide power and charge the batteries of many mobile computing devices. The cradles may also be used as a storage location to hold the portable device in a convenient position accessible by the user. For example, cellphones, PDA's, media devices, barcode scanners and other portable electronic devices use cradles to receive power from an external source. In addition, the cradle may provide contacts to exchange data between the mobile device and a fixed electronic device or communications node. It should be noted that throughout this description, the terms mobile device, mobile unit, terminal, portable device and mobile computing device are used interchangeably to describe the device that is inserted into the exemplary embodiments of the cradle.

Charging cradles for mobile computing devices typically comprise a molded sleeve with elements to mechanically lock a portion of the mobile device to the cradle. The locking elements ensure that the mobile device does not tip or otherwise come loose from the cradle, and that the electrical contacts on the mobile device maintain an electrical coupling with complementary electrical contacts on the cradle. A stable electrical coupling provides power to charge the battery and provides a path through which data may be uploaded and downloaded between the mobile device and another computing device coupled to the cradle.

Mobile devices are becoming ever smaller and lighter to increase their usefulness. The trend towards lighter devices reduces the need for large molded sleeves provided by the cradle to mechanically hold the mobile device and prevent it from falling out or tipping over. However, the need remains to maintain a good and stable electrical connection with the cradle.

A stable electrical connection with low contact resistance is typically achieved by pressing together the electrical contacts of the cradle and those of the mobile device with a sufficient contact force. In most conventional cradles, the contact force has at least a component acting in a direction that tends to retract or eject the mobile device from the cradle. The weight of heavier devices opposes the retracting force and may be sufficient to cause some deformation of the contacts that retain the mobile device in place within the cradle, and also provides a low contact resistance.

When lighter mobile devices are used, on the other hand, the forces necessary to achieve a low resistance contact may be greater than the weight of the mobile device. A latching mechanism such as a lock may be necessary to maintain the mobile device (or terminal) in the cradle, while the requisite force is applied to the electrical contacts. When the contact force pushes the mobile device out of the cradle, the lock may be large and complex, adding cost to the cradle.

According to the exemplary embodiments of the present invention, a geometric lock is provided on a cradle, together with a design of the electrical contacts that directs the contact force so that it does not cause the mobile device to be released from the cradle. The electrical contacts of the mobile device and of the cradle are shaped such that after the mobile device is in its final location in the cradle the direction of the contact force is not along a direction of insertion or retention of the mobile device in the cradle. According to the exemplary embodiments of the invention, the contact force may be in a direction that helps retain the mobile device within the cradle.

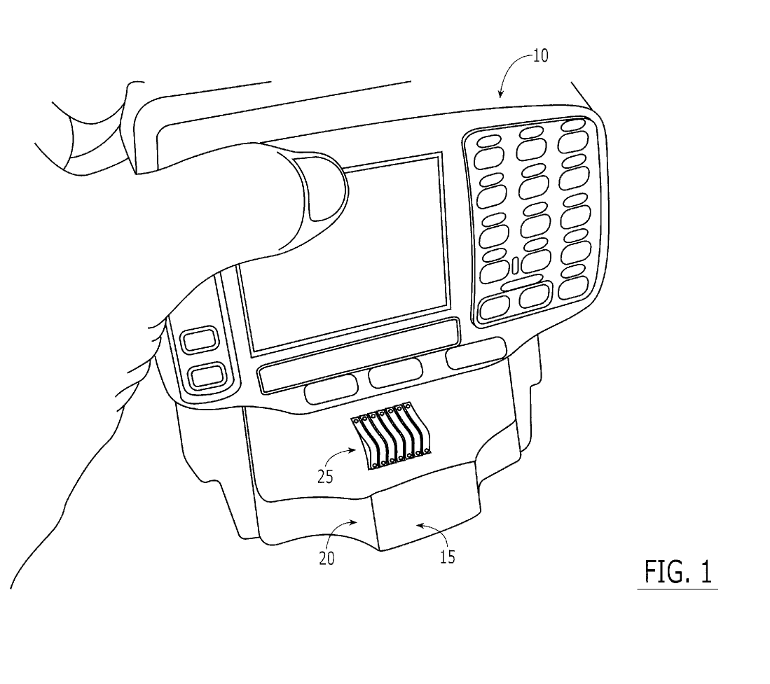

FIG. 1 shows an overview of an exemplary mobile computing device 10 and a charging cradle 15. The exemplary mobile device 10 may be a component of a wearable scanning system that includes a processing unit (for example the mobile device 10) and a scanning unit such as a ring scanner, back of hand scanner, etc. that is worn by the user. Alternatively, the mobile device 10 may be any type of communication device, portable computer, entertainment device or other mobile device with batteries to be charged and/or able to exchange data with a base unit.

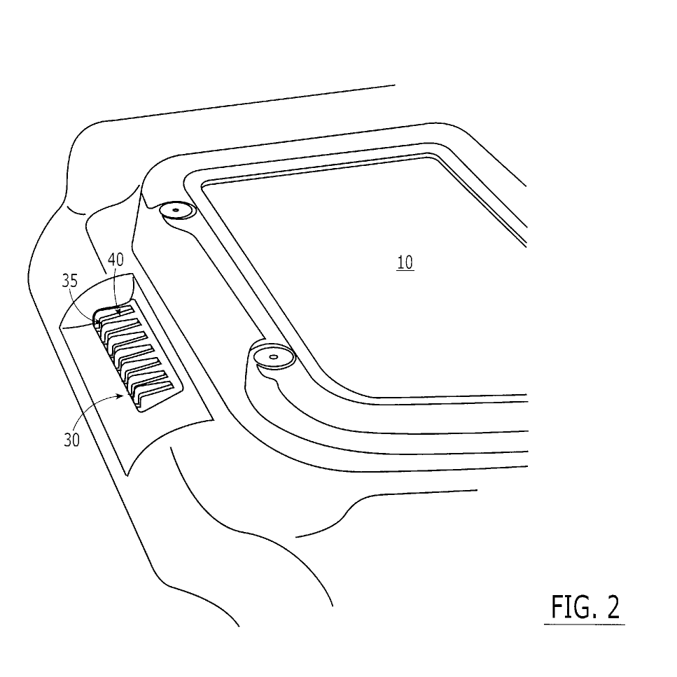

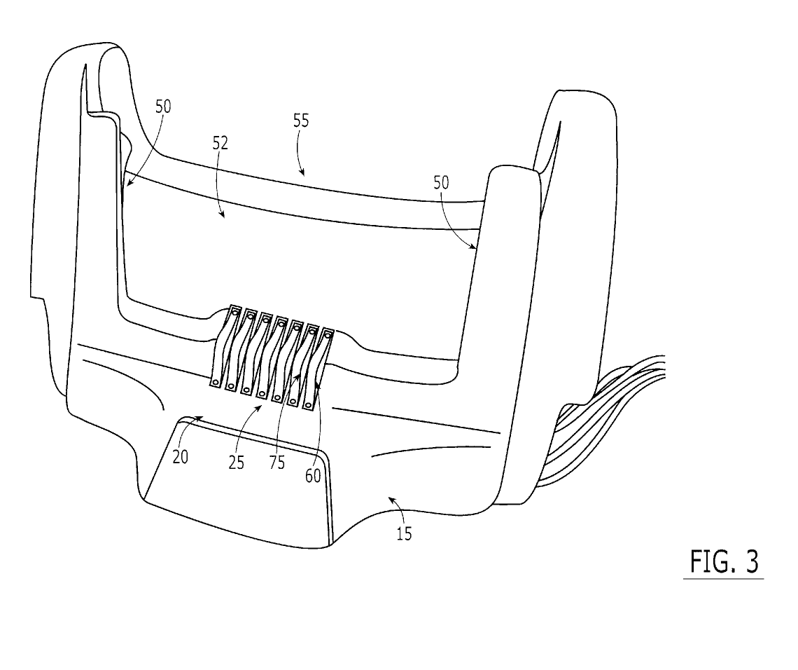

The mobile device 10 is powered by a battery coupled thereto, which can be charged through the cradle 15. The cradle 15, in turn, is connected to an external power supply for charging the battery. The exemplary cradle 15 provides a ledge 20 on which the mobile device 10 rests when it is coupled to the cradle 15. Guiding elements 50 (shown in detail in FIG. 3) such as slots, grooves and guides on the cradle 15 cooperate with the ledge 20 to ensure that the electrical contacts 25 of the cradle 15 align with the electrical contacts 30 (shown in detail in FIG. 2) of the mobile device 10.

FIG. 2 shows in greater detail the electrical contacts 30 of the mobile device 10 according to an exemplary embodiment of the invention. As shown, the exemplary electrical contacts 30 of the mobile device 10 are formed with surfaces at right angles, such that a first leg 35 lies in a plane substantially parallel to a bottom surface of the mobile device 10. A second leg 40 of the electrical contact 30 lies in a plane substantially parallel to a rear surface of the mobile device 10. In an exemplary embodiment of the invention, the electrical contacts 30 are formed of an array of individual contact strips having two perpendicular surfaces. In the example of FIG. 2, the array contains seven individual contact strips.

FIG. 3 shows the exemplary cradle 15 according to an embodiment of the invention. A pair of guides 50 are formed on right and left sides of a slot 52 defined by the body of the cradle 15. The slot 52 is shaped to fit corresponding retaining elements of the mobile device 10, such as a rail or ridge disposed on a rear surface of the mobile device 10. The exemplary slot 52 and guides 50 prevent movement of the mobile device 10 away from the cradle 15 in a direction substantially perpendicular to the direction of insertion and removal thereof. For example, if the mobile device 10 is inserted vertically into the cradle 15, the guides 50 prevent horizontal movement of the mobile device 10. A surface or groove 55 may be provided to support a battery that is externally coupled to the mobile device 10. Those skilled in the art will understand that the shape of the cradle 15 and or the guides 50, slot 52, or any other physical surface may be altered to accommodate the shape of the mobile device designed to be inserted into the cradle 15.

As shown in FIGS. 3, 4, 6 and 7 the exemplary electrical contacts 25 of the cradle 15 may be formed of an array of individual contact strips. Each of the contact strips has ends that are disposed within a respective slot 60 (shown in FIG. 3). As also shown in FIG. 3, when the mobile device 10 is not inserted into the cradle 15, the electrical contacts 25 extend away from the slots 60. However, when the mobile computing device is inserted into the cradle 15, the slots 60 provide a space in which the electrical contacts 25 may deflect.

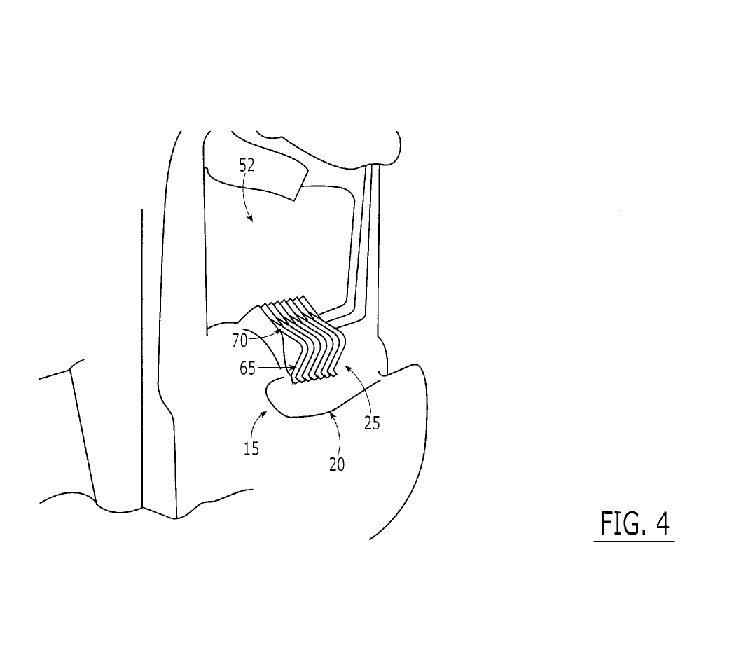

Referring to FIG. 4 that shows a side view of the cradle 15 and the electrical contacts 25, the electrical contacts 25 may comprise two surfaces formed at substantially right angles to one another. For example, a bottom leg 65 may extend away from the cradle 15 at an angle of about 45 degrees from both a horizontal and vertical axis of the cradle 15. In this description, the vertical axis will be considered to be the axis along which the mobile computing device 10 is inserted into the cradle 15, while the horizontal axis will be considered to be substantially perpendicular to this axis. Thus, the vertical axis as defined herein, may not necessarily be completely vertical with respect to a surface on which the cradle 15 is resting, but is rather defined along the insertion axis of the mobile device. A top leg 70 may extend at an angle of about 135 degrees from the horizontal axis and about 135 degrees from the vertical axis. Thus, as shown in FIG. 4, the top leg 70 and the bottom leg 65 of each contact 25 intersect at approximately a right angle that is rounded off to avoid sharp edges. Again, those skilled in the art will understand that the dimensions described above for the electrical contacts are only exemplary and that the dimensions may be altered without departing from the spirit and scope of the present invention.

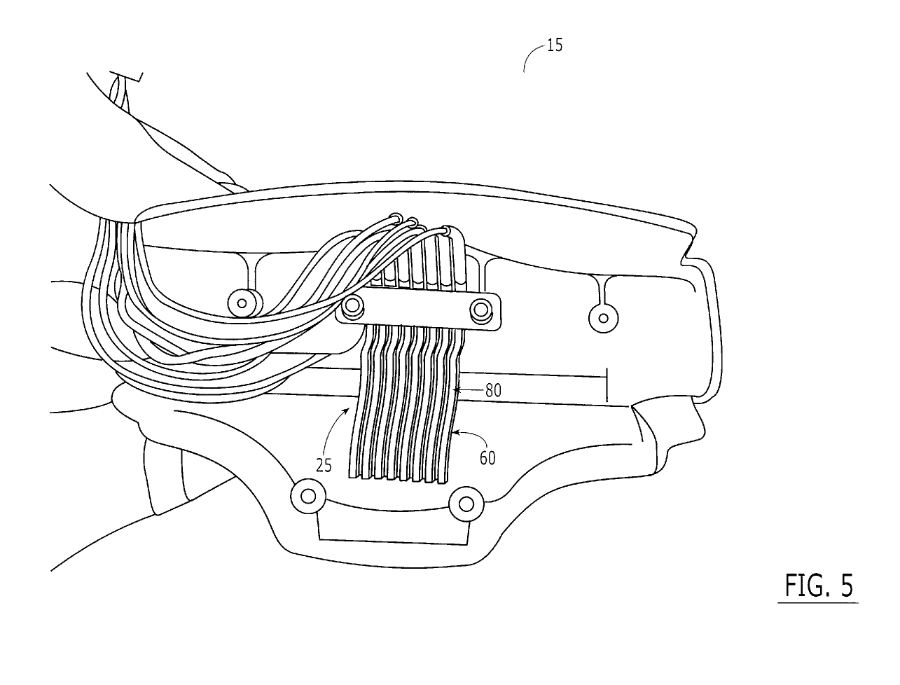

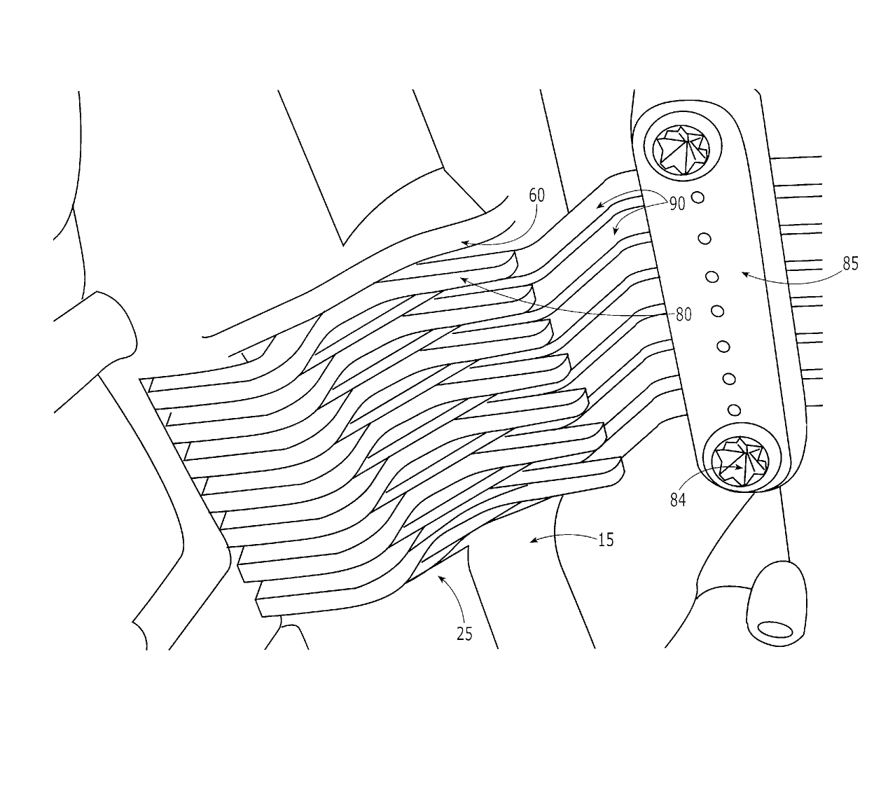

FIG. 8 shows a bottom view of the cradle 15. The bottom view shows the slots 60. In this embodiment, a spring member 80 is also shown. Each spring member 80 corresponds to one of the slots 60. Thus, as the electrical contacts 25 are deformed and push back into the slots 60 from their extended position, the corresponding spring member exerts an opposite force on the electrical contacts 25 to keep them in contact with the electrical contacts 30 of the mobile computing device 10. FIG. 8 also shows that a contact support body 85 is mounted to the cradle 15 with screws 84 and does not allow other portions of the contact to move relative to the cradle. FIG. 5 also shows that each of the electrical contacts 25 are electrically coupled to a cable or wire that may conduct power and/or data.

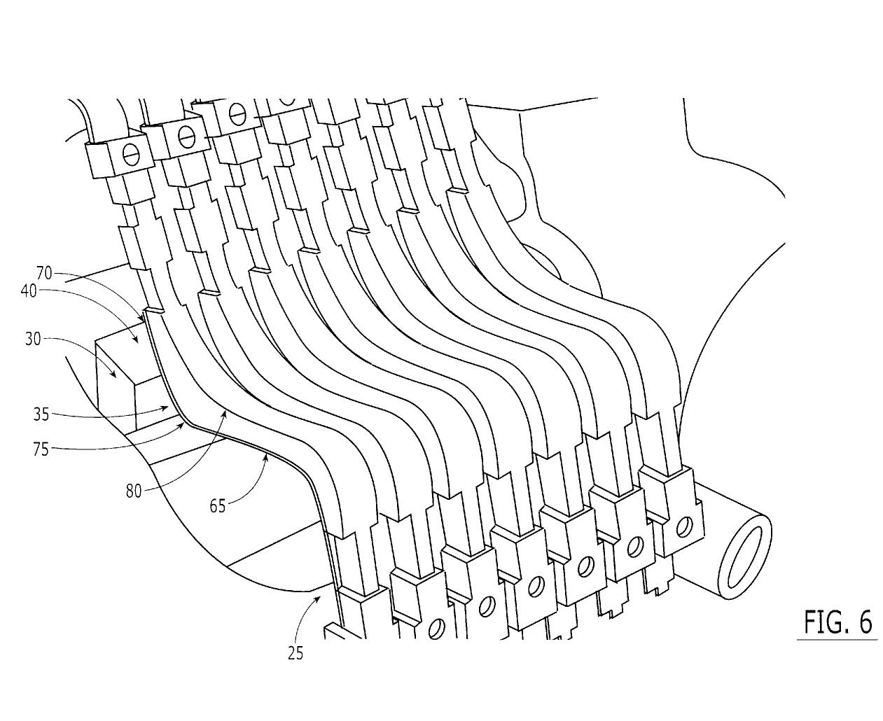

When the mobile device 10 is inserted into the cradle 15, the electrical contacts 30 of the mobile device 10 enter into contact with the corresponding electrical contacts 25 of the cradle 15. The electrical contacts 25 are pushed from their extended position towards the inside of the cradle 15 so that a contact flexible portion 90 (as shown in FIG. 8) deforms and other portions 65, 75, 70 (as shown in FIG. 6) of the contacts 25 move through the slots 60 (see FIG. 3). As the mobile device 10 slides in the slot 52 of the cradle 15, for example vertically downward, the first legs 35 (the horizontal legs) of the contacts 30 initially touch the top leg 70 of the electrical contacts 25 (as shown in FIG. 6).

As the mobile device 10 is inserted further towards the ledge 20 of the cradle 15, the electrical contacts 30 continue to push against the electrical contacts 25. This deforms the contact flexible portion 90, since portions of the electrical contacts 25 are flexible and/or may be mounted on a spring support allowing deformation of the contacts. In one example, the contact flexible portion 90 and the legs 65 and 70 of the electrical contacts 25 are made of a thin strip of electrically conducting metal such that the strip is flexible enough to be deformed by the contact described above. As described above, the cradle may also include spring members 80 that oppose the deformation and act as a force element opposing the deformation. Thus, the spring members 80 provide the contact force that pushes the electrical contacts 25 against the corresponding electrical contacts 30. However, it may be possible that the electrical contacts 25 themselves may be designed to deform, but also provide the force to oppose the deformation (e.g., the electrical contacts act as a spring, the electrical contacts are manufactured from a shape memory material, etc.).

In another example, the electrical contacts may include one or more spring elements along the body or the ends of the electrical contacts 25 to allow the electrical contacts 25 to deform when a force is exerted thereon. In this example, the spring elements may alleviate the need for the spring members 80 described above, because the spring elements included as part of the electrical contacts 25 may also act as a force element opposing the deformation and thus providing the contact force that pushes the electrical contacts 25 against the corresponding electrical contacts 30. In any case, according to the exemplary embodiments, the geometry of the electrical contacts 25 (and/or the springs 80) causes the contact force to react substantially to the insertion direction.

FIGS. 6-8 show in more detail the deformation of the corresponding contacts as the two components are brought together in the exemplary configuration. Initially, as shown in FIG. 6, as the mobile device 10 is inserted into the cradle 15, the first leg 35 of the electrical contacts 30 contact the top leg 70 of the electrical contacts 25 causing the initial deformation of the electrical contacts 25. As shown in FIG. 8, this initial sliding of the mobile device 10 acts to deform a flexible spring potion 90 (for those embodiments that include such flexible spring) and the spring members 80 begin to exert pressure as the electrical contacts 25 are deformed towards the inner side of the cradle 15. The contact support body 85 mounted to the cradle 15 with screws 84 does not allow other portions of the contact to move relative to the cradle, thereby creating a reactive force and moments while contact portion 90 of the cradle deforms. These reactive forces are transferred to the contact forces acting between the cradle contact 25 and the terminal vertical portion 40 while the terminal is fully inserted and resting in the cradle 15.

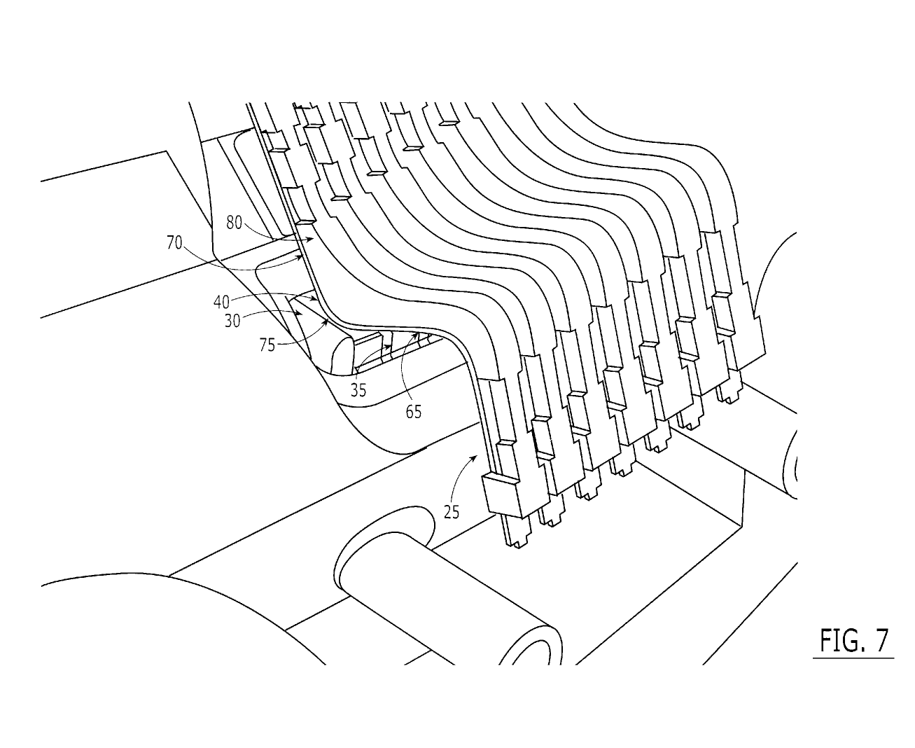

As shown in FIG. 7, when the mobile device 10 is fully inserted in the cradle 15, the electrical contact 30 of the mobile device 10 presses against the electrical contact 25 of the cradle 15. A tip portion 75 of the electrical contact 25 (e.g., where the top leg 70 and bottom leg 65 meet) is urged against and rests on the second (vertical) leg 40 of the electrical contact 30, such that a contact force acting substantially in the horizontal plane is applied therebetween. The contact force may be generated, for example, by elastic elements of the electrical contact 25 that oppose the displacement brought about by the electrical contact 30 when the mobile device 10 is inserted into the cradle 15 or any other method as described above.

According to an exemplary embodiment of the invention, the contact force acts on a plane that is substantially perpendicular to the weight of the mobile device 10 after the mobile device is fully inserted in the cradle. As described herein, the contact force acts perpendicularly to the insertion direction or axis of the mobile device 10 after the mobile device 10 is fully inserted in the cradle. Accordingly, the contact force does not have a component that acts on the mobile device 10 to retract or eject it from the cradle 15, since it is inserted in the cradle 15 in a generally vertical direction. In the exemplary embodiment, the contact force acts substantially horizontally. While the mobile device 10 is inserted in the cradle 15 and the contacts are starting to touch as shown in FIG. 6 and the mobile device contact horizontal portion 35 is touching the cradle contact portion 70 compound direction force is acting which has horizontal and vertical directional forces. However, these initial forces are small compared to the inertial forces generated by the user inserting the mobile terminal and also the mobile terminal weight is acting against the initial resistance forces, deforming the flexible portion 90 of cradle contact 25 until the cradle contact tip portion 75 touches the terminal contact vertical portion 40 and no vertical force is acting at this point on the terminal 10 to retract it from the cradle 15. The guides 50 may be shaped to retain the mobile device 10 within the slot 52 against the contact force, without the need for a locking mechanism to oppose movement of the mobile device 10 out of the cradle 15.

Those of skill in the art will understand that different force elements to generate the contact force acting in a direction substantially perpendicular to the direction of insertion may be used. For example, springs, resilient elements, coils, elastic elements etc. may urge the contacts of the cradle and of the mobile device together. The direction of the contact force may also have a component in the direction of insertion, thus helping to retain the mobile device in the cradle instead of retracting it. It will also be understood by those of skill in the art that the contacts of the mobile device may comprise force generating members analogous to those described herein to produce a contact force according to the present invention.

The present invention has been described with reference to specific exemplary embodiments. Those skilled in the art will understand that changes may be made in details, particularly in matters of shape, size, material and arrangement of parts. Accordingly, various modifications and changes may be made to the embodiments. The specifications and drawings are, therefore, to be regarded in an illustrative rather than a restrictive sense.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

1. A cradle for a mobile device, comprising:
a receiving portion to receive at least a portion of a body of the mobile device, the mobile device being inserted into the receiving poriton in an insertion direction; and
a cradle electrical contact electrically coupling with a corresponding mobile device electrical contact, the cradle electrical contact being deformed by physical contact with the mobile device electrical contact, wherein the cradle electrical contact appllies a force to the corresponding mobile device electrical contact in a direction substantially perpendicular to the insertion direction.

2. The cradle according to claim 1, wherein the cradle electrical contact is a plurality of cradle electrical contacts coupling electrically coupling with a plurality of mobile device electrical contacts.

3. The cradle according to claim 1, wherein the receiving portion further comprised guides that guide the mobile device while being inserted.

4. The cradle according to claim 3, wherein the guides further retain the mobile device within the cradle by preventing movement of the mobile device that is substantially perpendicular to the insertion direction.

5. The cradle according to claim 1, wherein the cradle electrical contacts further comprises a top leg and a bottom leg, the top and bottom legs being substantially perpendicular.

6. The cradle accoding to claim 1, further comprising:
a slot receiving the cradle electrical contact when deformed.

7. The cradle according to claim 1, wherein the cradle electrical contact is connected to one of a power source to charge a battery of the mobile device and a further computing devive to exchange data with the mobile device.

8. The cradle according to claim 1, wherein the receiving poriton further comprised a ledge for resting the mobile device when inserted in the cradle.

9. The cradle according to claim 1, further comprising:
at least one spring member, wherein when the electrical contact deforms, the spring member exerts a further force against the cradle electrical contact such that the cradle electrical contact exerts the force on the mobile device electrical contact.

10. The cradle accoding to claim 1 wherein the cradle electrical contact includes a spring element, the spring element providing one of the force in the direction substantially perpendicular to the insertion direction and a combined force in a plurality of directions.

11. A geometric lock for a cradle, comprising:
guides for receiving a mobile device into the cradle in an insertion direction; and
cradle electrical contacts for interfacing with corresponding mobile device electrical contacts, the cradle electrical contacts electrically coupling with the mobile device electrical contact by exerting a force substantially perpendicular to the insertion direction.

12. The geometric lock according to claim 11, wherein the cradle electrical contacts further comprise top and bottom legs, the top legs being disposed substantially perpendiculat to the bottom legs.

13. The geometric lock according to claim 11, further comprising:
a ledge for resting a bottom portion of the mobile device thereon.

14. The geometric lock according to claim 11, further comprising:
slots for receiving the cradle electrical contacts when the mobile device is inserted.

15. The geometric lock according to claim 11, wherein each of the cradle electrical contacts include a spring element to exert the force.

16. The geometric lock according to claim 11, further comprising:
spring members urging the cradle electrical contacts against the corresponding moble device electrical contacts.

17. The geometric lock according to claim 11, further comprising:
electrical connections operatively connecting the cradle electrical contacts to an external device.

18. The geometric lock according to claim 17, wherein the external device is one of a power supply for providing power to a battery of the mobile device and a computing device for receiving data for the mobile device.

19. A cradle for a mobile device, comprising:
a receiving means for at least a portion of a body of the mobile device, the mobile device being inserted into the receiving means in an insertion direction; and
contacting means for electrically contacting electrical contacts of the mobile device wherein the contacting means is deformed by physical contact with the electricl contacts of the mobile device, the contacting means applying a force to the electrical contacts in a direction substantially perpendicular to the insertion direction.

20. The cradle of claim 19, wherein the contacting means provides a combined force in a plurality of directions.

21. The cradle of claim 19, further comprising:
a spring means opposing a deformation of the contacting means, thereby causing the contacting means to apply the force.
